(19) United States
(12) Patent Application Publication
(10) Pub. No.: US 2016/0267005 A1
(43) Pub. Date: Sep. 15, 2016

(54) MEMORY RECLAMATION ON A COMPUTING DEVICE

(71) Applicant: QUALCOMM Incorporated, San Diego, CA (US)

(72) Inventors: Aravind Natarajan, Sunnyvale, CA (US); Gheorghe Calin Cascaval, Palo Alto, CA (US)

(21) Appl. No.: 14/824,142

(22) Filed: Aug. 12, 2015

Related U.S. Application Data
(60) Provisional application No. 62/132,125, filed on Mar. 12, 2015.

(51) Int. Cl. G06F 12/02; G06F 3/06

(52) U.S. Cl. CPC G06F 12/0253; G06F 3/065; G06F 3/0608; G06F 3/068; G06F 2212/702

(57) ABSTRACT

Various embodiments include methods for reclaiming memory in a computing device that may include storing a first pointer pointing to a first memory location storing the beginning of a data structure in which a plurality of threads executing on the computing device may concurrently access the data structure and storing a second pointer pointing to the current beginning of the data structure. In response to performing an operation on the data structure that changes the location of the beginning of the data structure from the first memory location to a second memory location, the second pointer may be updated to point to the second memory location. In response to determining that memory allocated to the data structure may be reclaimed, memory allocated to the data structure, including memory located at the first memory location pointed to by the first pointer, may be reclaimed.

### RELATED APPLICATIONS

This application claims the benefit of priority to U.S. Provisional Patent Application No. 62/132,125 entitled “Memory Reclamation on a Computing Device” filed Mar. 12, 2015, the entire contents of which are incorporated herein by reference.

### BACKGROUND

Various computing devices, including desktop computers, laptops, tablets, and mobile communication devices such as smart phones, execute applications and processes according to software instructions stored in memory. These processes may include a number of threads, which are discrete sequences of programmed instructions that may be managed by the operating system of the computing device. Multiple threads may exist within the same process, and may share resources such as memory, data values, and data structures. For example, a data structure such as an array may be stored in a single location in memory, but multiple threads may be able to access the data structure to read it or write to it concurrently. Such a data structure may be termed a concurrent data structure because multiple threads can access the data concurrently.

Conflicts may arise between threads accessing a concurrent data structure. For example, one thread may be reading a data structure at the same time another thread is writing to the data structure. One particular case in which conflicts may arise is memory reclamation. Memory reclamation is the process of reclaiming memory that had previously been used but is no longer needed so that the memory can be used for another purpose. This is done so that the computing device has enough free memory to allocate.

When a data structure is initiated, a portion of memory is allocated for storing the data structure. However, the data structure may grow or change over time, and sections of the allocated memory no longer used by the data structure may be reclaimed and used for another purpose. For example, in a first-in-first-out (FIFO) linked list type of data structure, new nodes are added to the end of the list while old nodes at the beginning of the linked list may be “popped,” or removed from the list. The memory used to store the popped nodes may be reclaimed by the computing device for another use. However, during concurrent access one thread may be attempting to pop a node while another node may be attempting to read the popped node. The node cannot be reclaimed after popping because another thread is still accessing it.

One way to avoid conflicts, such as conflicts during memory reclamation, is to have a lock-based data structure, such that only one thread may change the data structure at a time. The other threads are not allowed to change the data structure until the thread that is currently editing the data structure is finished. However, this does not work in a lock-free data structure where threads may always have concurrent access. Other methods have been developed to handle conflicts in lock-free data structures, such as using hazard pointers. Each thread may maintain an updateable list of nodes (hazard pointers) in the data structure that the thread is currently accessing. Each thread may check the hazard pointers of other threads concurrently accessing the data structure to identify and avoid conflicts. Another method is to store a list of free nodes in the data structure that are not currently being accessed by any thread. However, maintaining the hazard pointers or a free list introduces a large amount of processing overhead, thereby leading to slowdowns in performance. In addition, in the case of memory reclamation, it may be difficult to track when and which sections of memory may be reclaimed.

### SUMMARY

Various embodiment methods include methods and computing devices implementing methods for reclaiming memory in a computing device. Various embodiment methods may include storing, on the computing device, a first pointer pointing to a first memory location storing the beginning of a data structure in which a plurality of threads executing on the computing device may concurrently access the data structure. In some embodiments the method may further include storing, on the computing device, a second pointer, and performing an operation on the data structure, in which the operation changes the location of the beginning of the data structure from the first memory location to a second memory location. In some embodiments the method may further include updating the second pointer to point to the second memory location, determining whether memory allocated to the data structure may be reclaimed, and reclaiming memory allocated to the data structure, including memory located at the first memory location pointed to by the first pointer, in response to determining that memory allocated to the data structure may be reclaimed.

In some embodiments, the method may further include updating the first pointer to point to the second memory location. In some embodiments, the data structure may be a first-in-first-out (FIFO) linked list, and storing the second pointer may include setting the second pointer to point to the first memory location. In some embodiments, the second pointer may be an extension of the data structure. In some embodiments, the data structure may be a FIFO linked list that includes at least a first node and a second node, the first node may include a pointer to the second node, and performing an operation on the data structure may include popping the first node from the FIFO linked list so that the second node becomes the beginning of the FIFO linked list, in which the pointer to the second node is preserved.

In some embodiments, the data structure may be stored in a first portion of memory, and performing an operation on the data structure may include allocating a second portion of memory for the data structure, and copying the data structure from the first portion of memory to the second portion of memory. In such embodiments, the data structure may be a hash table or an array. In some embodiments, determining whether memory allocated to the data structure may be reclaimed may include obtaining, by one thread, exclusive access to memory locations of the data structure at the first memory location pointed to by the first pointer and any memory of the data structure located between the first memory location pointed to by the first pointer and the second memory location pointed to by the second pointer. In some embodiments, obtaining, by one thread, exclusive access to memory locations of the data structure at the first memory location pointed to by the first pointer and any memory of the data structure located between the first memory location pointed to by the first pointer and the second memory location pointed to by the second pointer may include locking the data structure, creating a copy of the first pointer, creating a copy of the second pointer, and unlocking the data structure. In such embodiments, reclaiming memory allocated to the data structure may include reclaiming the memory located at the first memory location pointed to by the copy of the first pointer and any memory of the data structure located between the first memory location pointed to by the copy of the first pointer and the second memory location pointed to by the copy of the second pointer. In some embodiments, determining whether memory allocated to the data structure may be reclaimed may include utilizing a table or counter to determine when only a single thread has exclusive access to memory locations of the data structure at the first memory location pointed to by the first pointer and any memory of the data structure located between the first memory location pointed to by the first pointer and the second memory location pointed to by the second pointer.

In some embodiments, the plurality of threads may concurrently access memory locations of the data structure outside of the memory located at the first memory location pointed to by the copy of the first pointer and any memory of the data structure located between the first memory location pointed to by the first pointer and the second memory location pointed to by the second pointer during reclamation of the memory located at the first memory location pointed to by the copy of the first pointer and any memory located between the first memory location pointed to by the first pointer and the second memory location pointed to by the second pointer. In some embodiments, reclaiming memory allocated to the data structure may include, by the plurality of threads, concurrently reclaiming non-overlapping portions of the memory allocated to the data structure.

Various embodiments further include a computing device having a memory and a processor coupled to the memory and configured with processor executable instructions to perform operations of the methods described above. Various embodiments include a computing device having means for performing functions of the methods described above. Various embodiments include a non-transitory processor-readable storage medium having stored thereon processor-executable instructions configured to cause a processor of a computing device to perform operations of the methods described above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the claims.

FIG. 1 is a block diagram of a computing device for use with various embodiments.

FIGS. 2-4 are diagrams of a FIFO linked list according to various embodiments.

FIG. 5 is a diagram of a FIFO linked list with an additional pointer for assisting in memory reclamation according to various embodiments.

FIGS. 6A-6E are diagrams of a FIFO linked list with one or more additional pointers for assisting in memory reclamation according to various embodiments.

FIGS. 7-8 are diagrams of an array according to various embodiments.

FIG. 9 is a diagram of an array with additional pointers for assisting in memory reclamation according to various embodiments.

FIGS. 10A-10E are diagrams of an array with additional pointers for assisting in memory reclamation according to various embodiments.

FIGS. 11A and 11B are process flow diagrams illustrating methods for reclaiming memory in a computing device according to various embodiments.

FIG. 12 is a component block diagram of a mobile communication device suitable for implementing some embodiment methods.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the written description or the claims.

As used herein, the term “computing device” refers to any one or all of cellular telephones, smart phones, personal or mobile multi-media players, personal data assistants, desktop computers, laptop computers, tablet computers, servers, smart books, palm-top computers, wireless electronic mail receivers, multimedia Internet-enabled cellular telephones, wireless gaming controllers, and similar personal or enterprise electronic devices that includes a programmable processor and memory.

Computing devices execute various processes, which may include one or more threads within each process. Threads may share access to the same data structures, such as linked lists, arrays, and hash tables. The data structure is stored in a portion of memory in the computing device. During runtime, the threads may change the data structure such that some sections of memory being used by the data structure are no longer needed (e.g. removing nodes from a FIFO linked list). These sections of memory may be reclaimed by the computing device and used for other purposes, such as storing additional data structures or values. Memory reclamation may occur, for example, when a destructor function for an object in the data structure is called. However, when multiple threads are concurrently accessing the data structure, memory reclamation may not be possible because certain threads may be attempting to access parts of the data structure that would otherwise be eligible for reclamation (e.g. one thread accessing a node of a linked list that has been removed from the list by another thread).

There are several methods to resolve conflicts for a lock free data structure in which one or more threads are permitted concurrent access to the data structure. For example, hazard pointers or free lists may be used to track the memory locations of nodes in the data structure currently being accessed by all threads or which are not being accessed by any thread. However, upkeep of such information is intensive and may introduce a large amount of overhead into the execution of the threads. This may slow down performance on the computing device.

In overview, various embodiments provide systems and methods for reclaiming memory of a lock free data structure in a computing device using one or two additional pointers per data structure, which introduces minimal overhead. An initial pointer is stored that points to the memory location of the beginning of the data structure when it is first initialized or after a memory reclamation has already been performed on the data structure. This initial pointer does not change even though the memory location of the beginning of the data structure may change. A second pointer is used to track the current memory location of the beginning of the data structure. Threads may concurrently access and edit the data structure in the meantime, and may change the location of the beginning of the data structure. The second pointer is updated as the beginning of the data structure changes. At a certain point, when memory allocated to the data structure may be reclaimed, a thread may initiate memory reclamation for the data structure in which memory located at the initial pointer and, if desired, any memory locations between the initial pointer and the second pointer may be reclaimed. Thus, the use of the initial pointer provides a low overhead mechanism (requiring only one more pointer per data structure) for identifying memory suitable for reclamation.

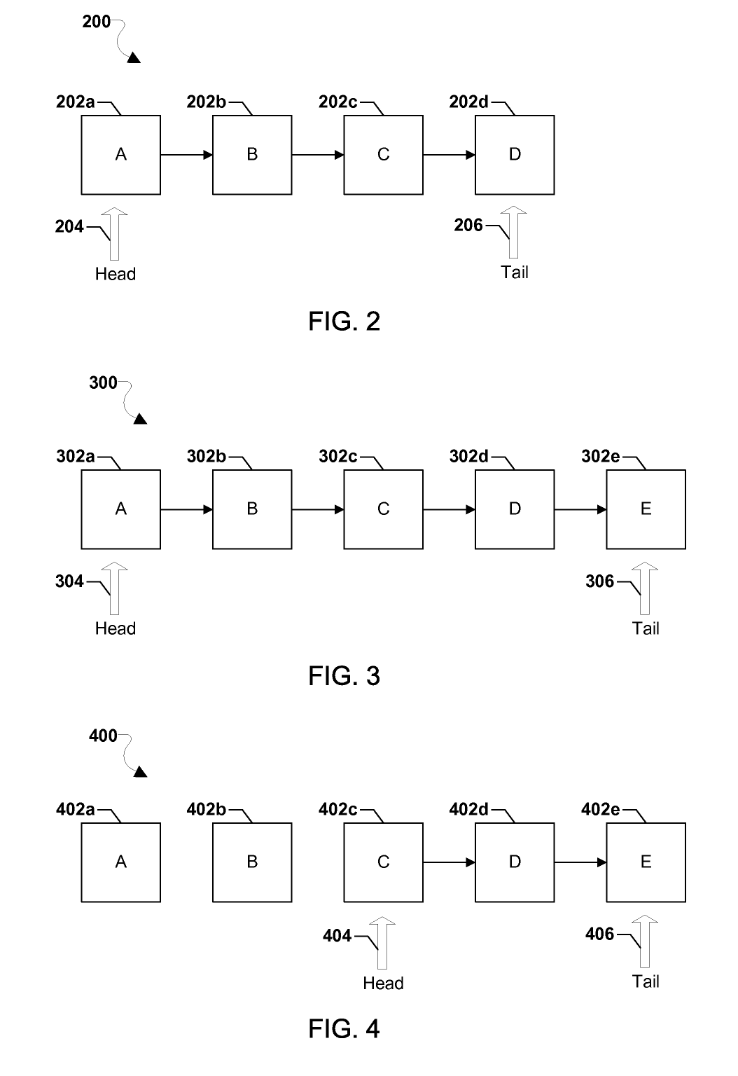

An example of a data structure that may benefit from the various embodiments is a first-in-first-out (FIFO) linked list. A FIFO linked list uses pointers that to the head and tail of the list of memory blocks, while each memory block includes a pointer to the next block in the list. In the various embodiments, an initial pointer is stored that points to the initial head of the linked list. As nodes are added to the linked list but before nodes are removed from list the pointer to the head of the list will continue point to the first block in the list just like the initial pointer. As nodes are popped from the linked list by one or more threads, the head of the linked list moves and the head pointer moves along with it, but the initial pointer remains unchanged pointing to the memory that was the first block in the list when it was first created. Also, pointers linking the popped nodes are also preserved. When memory allocated to the data structure can be reclaimed, a computing device processor (such as a processor executing a destructor function) starts at the memory location of the initial pointer and reclaims the memory used by each popped node, using the preserved inter-node pointers to traverse the popped section of the linked list. The processor stops reclamation when it reaches the memory location of the head pointer, at which point the initial pointer may be updated (or a new initial pointer created) to point to the current head of the linked list. In this manner memory located at the initial pointer and any memory locations between the initial pointer and the current head pointer may be reclaimed while the linked list remains in use. Additional details of memory reclamation for a FIFO linked list is described with reference to FIGS. 2-6E.

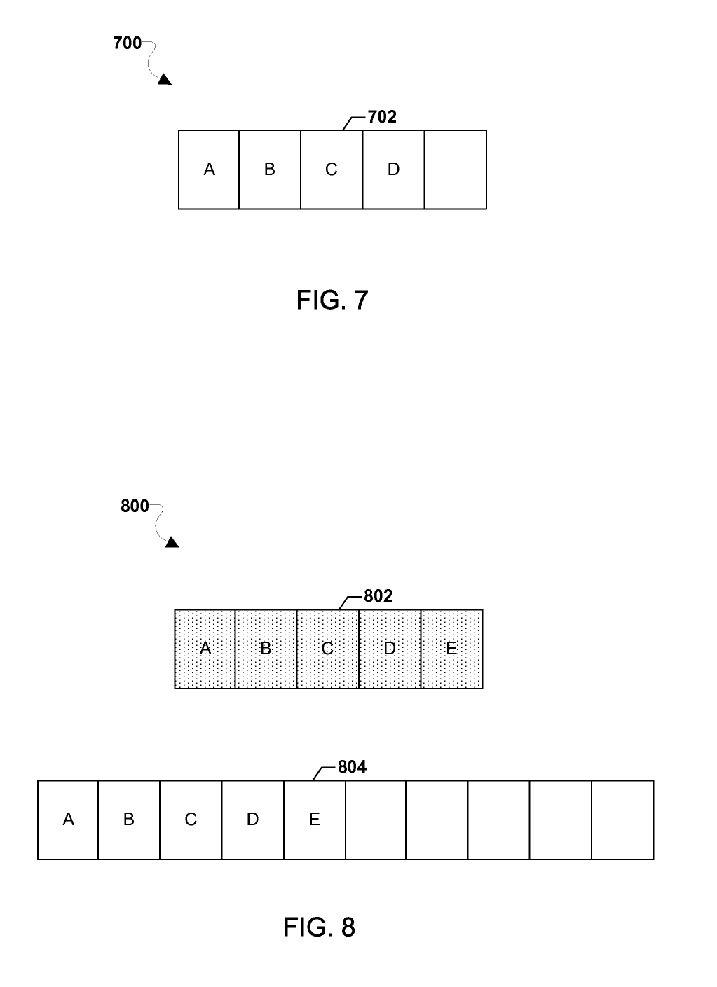

Another example of a data structure that may benefit from the various embodiments is an array or a hash table. When the array is initialized allocating a portion of memory for the array, an initial pointer is stored that points to the memory location of the beginning of the array. One or more threads may add data to the array so that at some point the array may become full. When that happens, the computing device processor may allocate a new, larger portion of memory for the array and copy the existing array into the new portion of memory so that it may continue to expand. A second pointer (“next pointer”) is stored and associated with the original copy of the array, and the next pointer is updated to point to the memory location of the newly created larger array. When memory allocated to the data structure can be reclaimed, the processor starts at the memory location of the initial pointer and reclaims the memory used by the original array, stopping when it reaches the next pointer pointing to the beginning of the larger array. At that point the initial pointer may be updated to point to the memory location of the beginning of the larger array. In this manner all memory locations used by the original smaller array may be reclaimed. Additional details of memory reclamation for an array or hash table is described with reference to FIGS. 7-10E.

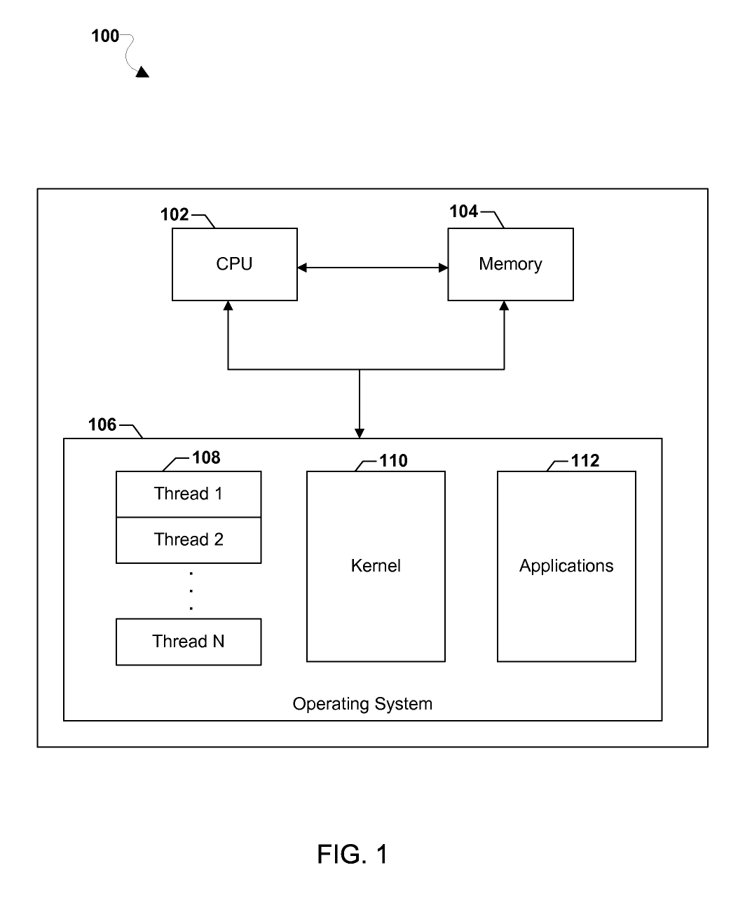

FIG. 1 is a functional block diagram of a computing device 100 suitable for implementing various embodiments. The computing device 100 may be, among other things, a desktop computer, laptop, tablet, any type of mobile electronic device, a server or any type of consumer or enterprise electronic device. The computing device 100 includes a central processing unit (CPU) 102 for executing software instructions, and a memory 104 for storing code and data. The memory 104 may be a non-transitory computer-readable storage medium that stores processor-executable instructions. The memory 104 may store an operating system 106, as well as applications 112, a kernel 110, and one or more threads 108. The threads 108 may be part of processes within the kernel 110, the applications 112, or other parts of the operating system 106. The memory 104 may also store data structures accessible by the threads 108.

The computing device 100 may also include various other components not illustrated in FIG. 1. For example, the computing device 100 may include a number of input, output, and processing components such as a speaker, microphone, modem, transceiver, subscriber identification module (SIM) card, keypad, mouse, display screen or touchscreen, various connection ports, audio or graphics processor, additional hard drives, and many other components known in the art.

FIG. 2 illustrates an example of a linked list 200 that may be stored in the memory 104 of the computing device 100 and accessed by the threads 108. The linked list 200 is a FIFO linked list, which means that new nodes are added to the end of the linked list 200 while old nodes are removed, or popped, from the beginning of the linked list 200. For example, a thread may call a push( ) function to add nodes to the linked list 200 or call a pop( ) function to remove nodes from the linked list 200. The linked list 200 includes four nodes 202a through 202d. Each node includes a data structure or value and a pointer to the next node (inter-node pointer), shown in FIG. 2 as arrows between the nodes 202a-202d. Thus, the head node 202a has a pointer pointing to the next node in the linked list 200, the node 202b, the node 202c, and so on. The linked list 200 also includes a head pointer 204 and a tail pointer 206. The head pointer 204 points to the memory location of the beginning of the linked list 200, which is the head node 202a. The tail pointer 206 points to the memory location of the end of the linked list 200, which is the node 202d.

FIG. 3 illustrates the process of adding a node to the linked list 200 in FIG. 2, for example by a thread calling a push( ) function on the linked list 200. The node 302e is added to the end of linked list 200 to produce linked list 300. Linked list 300 includes nodes 302a-302e, a head pointer 304 pointing to the head node 302a, and a tail pointer 306. In contrast to the tail pointer 206 in FIG. 2 that pointed to the node 202d, the tail pointer 306 now points to the new tail node of the linked list 300, the node 302e.

FIG. 4 illustrates the process of removing nodes from the linked list 300 in FIG. 3, for example by a thread calling a pop( ) function on the linked list 300. The nodes 402a and 402b are removed, or popped, from the beginning of the linked list 300, resulting in linked list 400. The linked list 400 includes nodes 402c-402e, a tail pointer 406 pointing to tail node 402e, and a head pointer 404. In contrast to the head pointer 304 in FIG. 3 that pointed to the node 302a, the head pointer 404 now points to the new head node of the linked list 400, node 402c. The nodes 402a and 402b are no longer part of the linked list 400, and the inter-node pointers of the popped nodes may also be deleted.

Adding or removing nodes from a FIFO linked list, such as illustrated in FIGS. 2-4, may be done by multiple threads accessing the linked list. The linked list may be a lock free data structure such that multiple threads may concurrently access and edit the linked list. For example, one thread may remove the nodes 402a and 402b from a linked list as illustrated in FIG. 4. The popped nodes 402a and 402b are no longer part of the linked list 400, but other threads may still be accessing the data in the nodes 402a and 402b. Thus, the memory that is storing the nodes 402a and 402b may not be reclaimed by the computing device while one or more threads are still accessing them. Also, the inter-node pointers of the nodes 402a and 402b may be deleted, so that the memory no longer retains the linkage sequence of the popped nodes. This may make memory reclamation more difficult as it may be difficult to track the memory location of all popped nodes of a linked list. Hazard pointers or free lists may be used to avoid conflicts in memory reclamation of linked lists, but these methods introduce a large amount of overhead. In addition, free lists have a finite size so that if there are more free (i.e. popped) nodes than can be stored in the free list, those nodes may not be reclaimed until the program that created the linked list terminates.

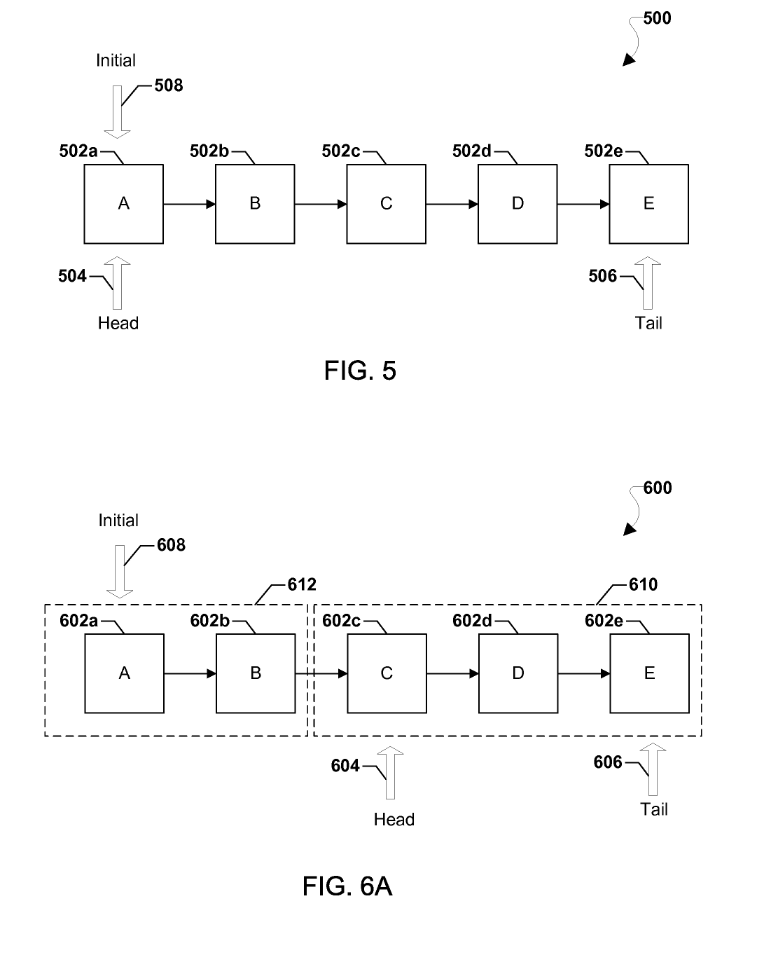

In order to implement efficient memory reclamation of a lock free data structure with low overhead, an additional pointer may be created and stored that tracks the beginning of the initial linked list. This is illustrated in FIG. 5. A FIFO linked list 500 includes nodes 502a-502e, a head pointer 504 pointing to the node 502a, and a tail pointer 506 pointing to the node 502e. An initial pointer 508 is created and stored that points to the memory location of the beginning of the linked list 500, the node 502a. Thus, the initial pointer 508 and the head pointer 504 are currently pointing to the same node, the node 502a.

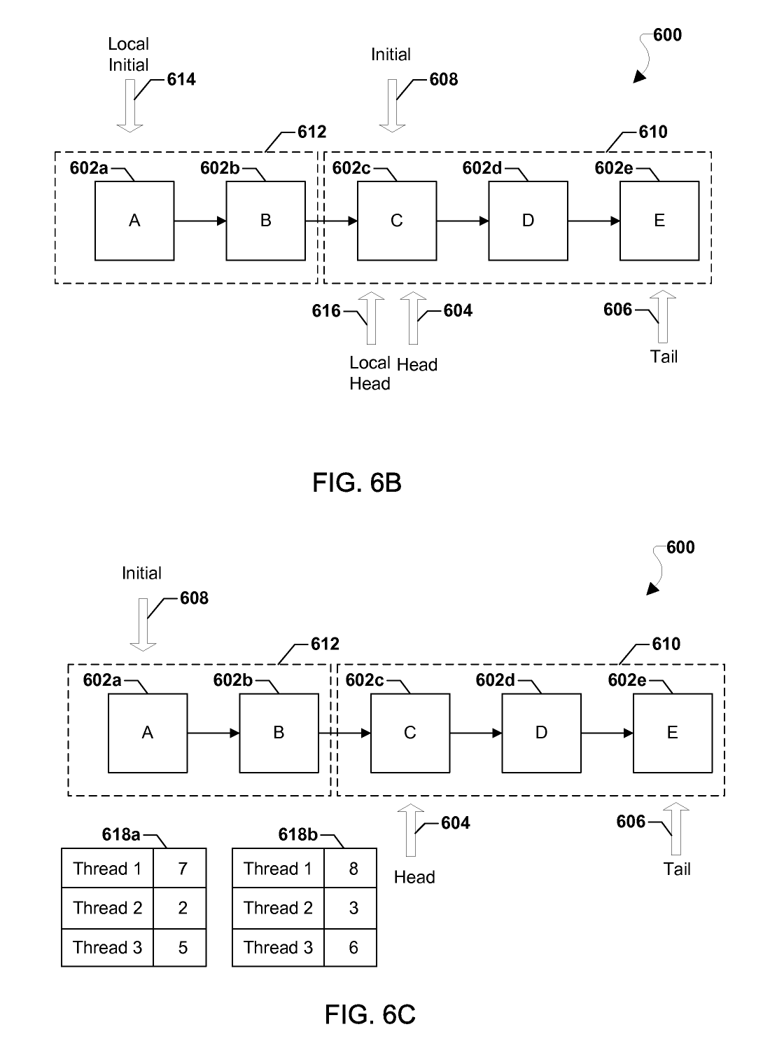

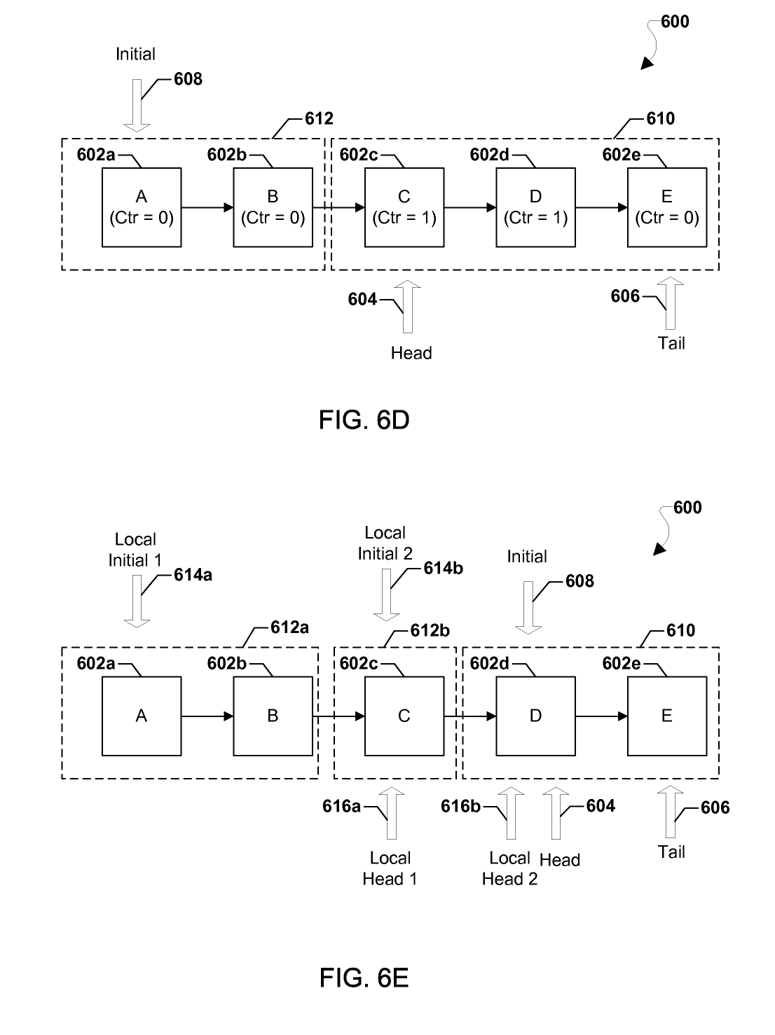

When one or more threads remove a node from the linked list 500, the head pointer 504 changes to point to the new head node, but the initial pointer 508 does not change. This is illustrated in FIG. 6A, where nodes 502a and 502b have been popped from the linked list 500, resulting in linked list 600. The linked list 600 includes nodes 602c-602e, a head pointer 604 pointing to the current head node 602c and a tail node 606 pointing to the current tail node 602e. The initial pointer 608 still points to the node 602a, which has been removed from the linked list 600. In addition, the inter-node pointers of the nodes 602a and 602b have been preserved such that the node 602a points to the node 602b, which points to the node 602c in the linked list 600. The nodes in the linked list 600 may be classified as part of an active data structure 610 or a passive data structure 612. The active data structure 610 may include the nodes 602c through 602e that have not been popped from the linked list 600, while the passive data structure 612 may include the nodes 602a and 602b that have been popped from the linked list 600 but may still be accessed by threads.

Multiple threads may be concurrently accessing the linked list 600, and one or more of those threads may also be accessing the passive data structure 612 (i.e. nodes 602a and 602b), even though they have been removed from the linked list 600. As long as multiple threads are concurrently accessing any of the nodes in the passive data structure 612, memory reclamation may not be performed on the linked list 600.

In some embodiments, a single dedicated reclamation thread may reclaim memory in the linked list 600 (i.e., only that thread may change the initial pointer 608). Alternatively, multiple threads may have the ability to reclaim memory from the linked list 600. There are a number of ways to implement memory reclamation on the linked list 600 utilizing the initial pointer 608, some of which are illustrated in FIGS. 6B-6E. FIG. 6B illustrates one example implementation for reclaiming memory from the linked list 600. When memory allocated to the data structure can be reclaimed (i.e., when only one thread is accessing the passive data structure 612), the thread may request that the data structure be locked by that thread. The processor executing the thread may then create local copies of the initial pointer 608 and the head pointer 604, shown as a local initial pointer 614 that points to the node 602a and a local head pointer 616 that points to the current head of the linked list 600, the node 602c. The processor executing the thread may update the initial pointer 608 to point to the current head of the linked list 600, which is the node 602c in the illustrated example. If there is a dedicated thread for performing memory reclamation, it may not be necessary to create the local head pointer 616 because only the thread dedicated to performing memory reclamation may move the initial pointer 608.

After creating the local initial pointer 614 and the local head pointer 616, the processor executing the thread may release the exclusive lock on the linked list 600. The process of locking and unlocking the linked list 600 may ensure that only the thread that is performing the memory reclamation has access to the passive data structure 612. Any thread that accesses the linked list 600 after the lock is released will start at the node pointed to by the head pointer 604 (i.e., the node 602c). Thus the other concurrent threads may still access the active data structure 610 during memory reclamation, but they do not have access to the passive data structure 612.

The processor executing the thread may start the memory reclamation at the memory location pointed to by the local initial pointer 614, i.e. the memory location of the node 602a. The processor executing the thread then traverses the popped nodes and reclaims the memory used to store each popped node until it reaches the local head pointer 616, which points to the current head of the linked list 600. In other words, the processor executing the thread reclaims the memory used to store the node 602a and then uses the inter-node pointer of the node 602a to find the node 602b. The processor executing the thread reclaims the memory used to store the node 602b and then uses the inter-node pointer of the node 602b to find the node 602c. Because the local head pointer 616 points to the node 602c, the processor knows that it has reached the head of the active data structure 610 of the linked list 600 and stops memory reclamation. Thus, the processor executing the thread may reclaim the memory at the memory location indicated by the local initial pointer 614 and any memory between the memory locations indicated by the local initial pointer 614 and the local head pointer 616. During the reclamation process, other threads may concurrently access the active data structure 610. However, those threads may not access the passive data structure 612 because the thread that is performing the memory reclamation had previously had exclusive access to the passive data structure 612.

As threads continue to change the linked list 600, the head pointer 604 continually points to the current head node of the linked list 600 while the initial pointer 608 points to the location of the head node that existed at the end of the last memory reclamation. Once a subsequent memory reclamation is initiated, the memory location indicated by the initial pointer 608 and any memory locations between the initial pointer 608 and the head pointer 604 may be reclaimed, and the initial pointer 608 is once again updated. This process may continue until the linked list 600 is completely deleted. In this manner, the use of the initial pointer 608 allows for efficient memory reclamation for a lock free data structure such as a FIFO linked list with low overhead.

FIG. 6C illustrates an example implementation for reclaiming memory from the linked list 600 when there is a single dedicated reclamation thread. A table 618a may be created that is associated with the linked list 600. The table 618a may include entries for every thread that may access the linked list 600, along with a sequence number or counter for the number of times that thread has accessed the linked list 600. In the example illustrated in FIG. 6C, the table 618a shows that there are three threads that have accessed the linked list 600, with Thread 1 accessing the linked list 600 seven times, Thread 2 accessing the linked list 600 two times, and Thread 3 accessing the linked list 600 five times. The table 618a may or may not include an entry for the dedicated reclamation thread.

To initiate memory reclamation, the processor executing the dedicated reclamation thread may read or store a local copy of the head pointer 604 and take a snapshot of the table 618a. The processor executing the dedicated reclamation thread may then wait until every sequence number in the table 618a has been incremented by at least one (except for the entry for the dedicated reclamation thread, if included in the table) as shown in table 618b. This means that every thread has finished its previous access, and has initiated a new access to the linked list 600. When a new access is initiated, the threads start at the node pointed to by the head pointer 604 (i.e., the node 602c), thus ensuring that no threads are still accessing the passive data structure 612. Once the processor executing the dedicated reclamation thread determines that every thread is only accessing the active data structure 610 (for example, by comparing the snapshot of the table 618a with the current state of the table 618b), memory reclamation may be initiated on the passive data structure 612. The processor executing the dedicated reclamation thread may reclaim memory starting from the node pointed to by the initial pointer 608 (i.e., the node 602a) until it reaches the node pointed to by the head pointer 604 (i.e., the node 602c), and then modify the initial pointer 608 to point to the same memory location as the head pointer 604.

FIG. 6D illustrates another example implementation for reclaiming memory from the linked list 600 when there is a single dedicated reclamation thread. Each node in the linked list 600 may store an additional counter. The counter may initiate whether a thread is currently accessing that node. For example the counter may be set to zero if no thread is accessing the node, such as illustrated for the nodes 602a, 602b, and 602e. When a thread accesses the node, the thread may increment the counter to one, such as illustrated for the nodes 602c and 602d. Once the thread finishes accessing the node, the thread may decrement the counter back to zero.

The processor executing the dedicated reclamation thread may store a local copy of the head pointer 604 and monitor the counters for each node in the passive data structure 612. Once the counters for each node in the passive data structure 612 are all zeros, it indicates that no threads are still accessing the passive data structure 612. All new accesses will start at the location of the head pointer 604 (i.e. the node 602c), so only the active data structure 610 is being accessed. At that point, the processor executing the dedicated reclamation thread may reclaim memory starting from the node pointed to by the initial pointer 608 (i.e. the node 602a) until it reaches the node pointed to by the head pointer 604 (i.e. the node 602c), and then modify the initial pointer 608 to point to the same memory location as the head pointer 604.

FIG. 6E illustrates an example implementation for concurrent memory reclamation by multiple threads that have the ability to reclaim memory. Multiple threads may obtain exclusive access to non-overlapping portions of the passive data structure, and thus each thread may reclaim memory on those portions of the passive data structure in parallel. The processor executing a first thread may, for example, pop the nodes 602a and 602b from the linked list 600 such that the head pointer points to the node 602c. The nodes 602a and 602b become part of passive data structure 612a. The processor executing the first thread may initiate memory reclamation on the passive data structure 612b in a manner similar to that described with reference to FIG. 6B. That is, the processor executing the first thread may obtain an exclusive lock on the linked list 600, create local copies of the initial pointer 608 and the head pointer 604 (e.g. local initial pointer 614a and local head pointer 616a), move the initial pointer 608 to the node 602c (for example, by performing a compare- and swap operation between the initial pointer 608 and the head pointer 604), and unlock the linked list 600.

While the processor executing the first thread reclaims memory in the passive data structure 612a, the processor executing a second thread may access the linked list 600 and pop the node 602c from the linked list 600. The head pointer 604 now points to the node 602d, and the node 602c becomes part of the passive data structure 612b. The processor executing the second thread may also initiate memory reclamation on the passive data structure 612b in a manner similar to that described with reference to FIG. 6B. That is, the processor executing the second thread may obtain an exclusive lock on the linked list 600, create local copies of the initial pointer 608 and the head pointer 604 (e.g. local initial pointer 614b and local head pointer 616b), move the initial pointer 608 to the node 602d (for example, by performing a compare- and swap operation between the initial pointer 608 and the head pointer 604), and unlock the linked list 600. The processor executing the second thread may then reclaim the memory in the passive data structure 612b while the processor executing the first thread is reclaiming memory in the passive data structure 612a. This process is extendable to any number of concurrent threads to reclaim non-overlapping portions of the passive data structure.

Memory reclamation of other data structures may also benefit from the use of an initial pointer. For some classes of data structures, when the data structure reaches a certain size, a new data structure may be allocated and the data copied from the old data structure into the new data structure. The new data structure may be larger or smaller than the old data structure. Examples of data structures that may have this quality include arrays and hash tables, and FIG. 7 shows an example of such a data structure 700. The data structure 700 may be an array 702 with five cells as illustrated in FIG. 7. Four of the cells in the array 702 have data values stored in them (represented as letters A through D) and the fifth cell is currently empty. Multiple threads may access and edit the array 702. When the array 702 was initiated, the computing device processor may have allocated a portion of memory for the array 702 that was large enough to store five cells. However, if the array 702 becomes full and needs more memory to expand, the processor may allocate a second larger portion of memory and copy the array 702 into the new memory location. This is illustrated in FIG. 8.

FIG. 8 illustrates data structures 800 that include an array 802. In the illustrated example the array 802 has five cells, and a thread may have added a value to the array 802 such that all five cells now have data values in them. Thus, the array 802 is full. The computing device processor may allocate another portion of memory, which may increase the amount of memory used to store the array 802. For example, the portion of memory allocated may be large enough to store ten cells instead of five. The processor then copies the contents of the array 802 into the larger portion of memory, resulting in array 804 at the new memory location. The memory used by the array 802 is no longer needed and may be reclaimed by the computing device. However, one or more threads may still be accessing the array 802 while the array 804 is created. This means that the memory used by the array 802 is not reclaimed while still being accessed. Hazard pointers or free lists may be used to avoid conflicts in memory reclamation of arrays or hash tables, but these methods introduce a large amount of overhead.

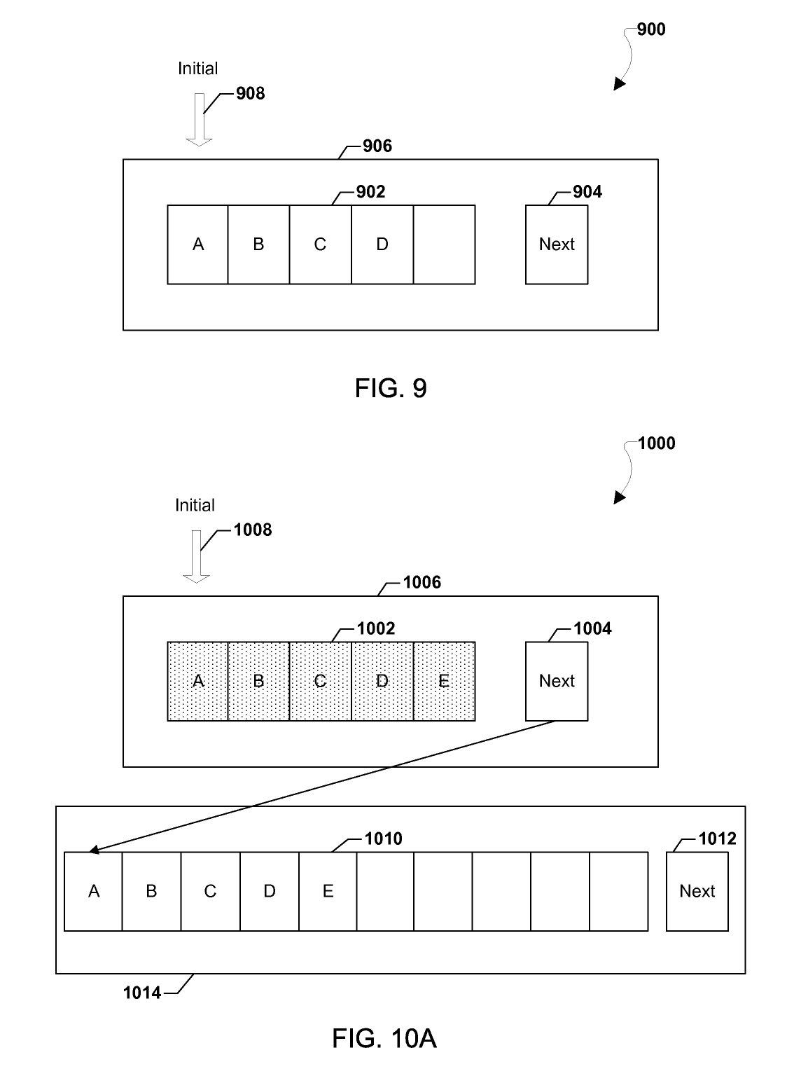

In order to implement efficient memory reclamation of a lock free array or hash value with low overhead, two additional pointers may be created and stored. This is illustrated in FIG. 9. FIG. 9 illustrates a data structure 900 including an array 902. The array 902 is extended by associating it with a next pointer 904. The combination of the array 902 and the next pointer 904 may be referred to as a container structure 906. In addition, an initial pointer 908 is created and stored. The initial pointer 908 points to the memory location of the beginning of the container structure 906, which for example may be the beginning of the array 902.

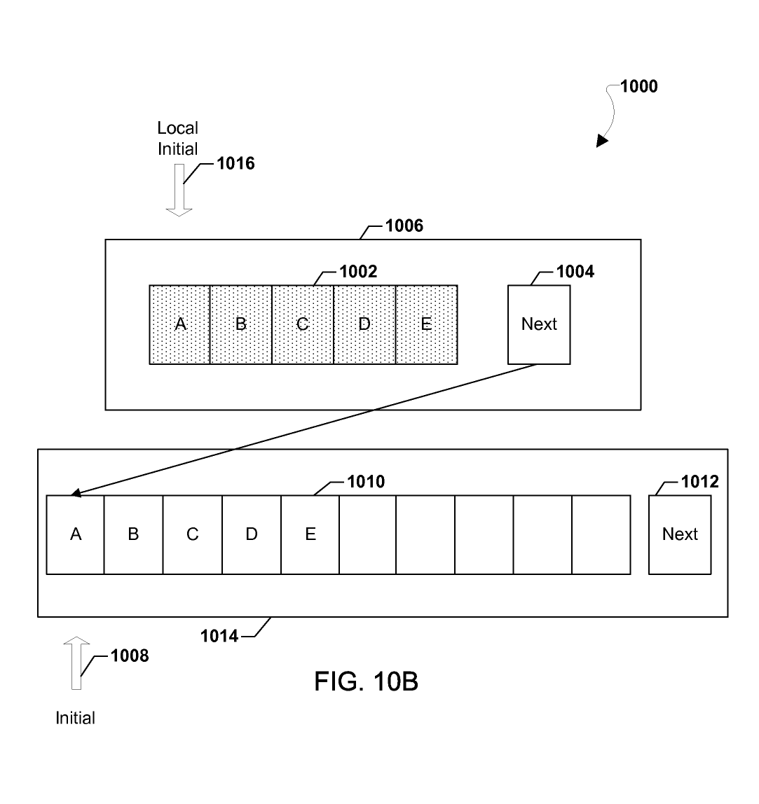

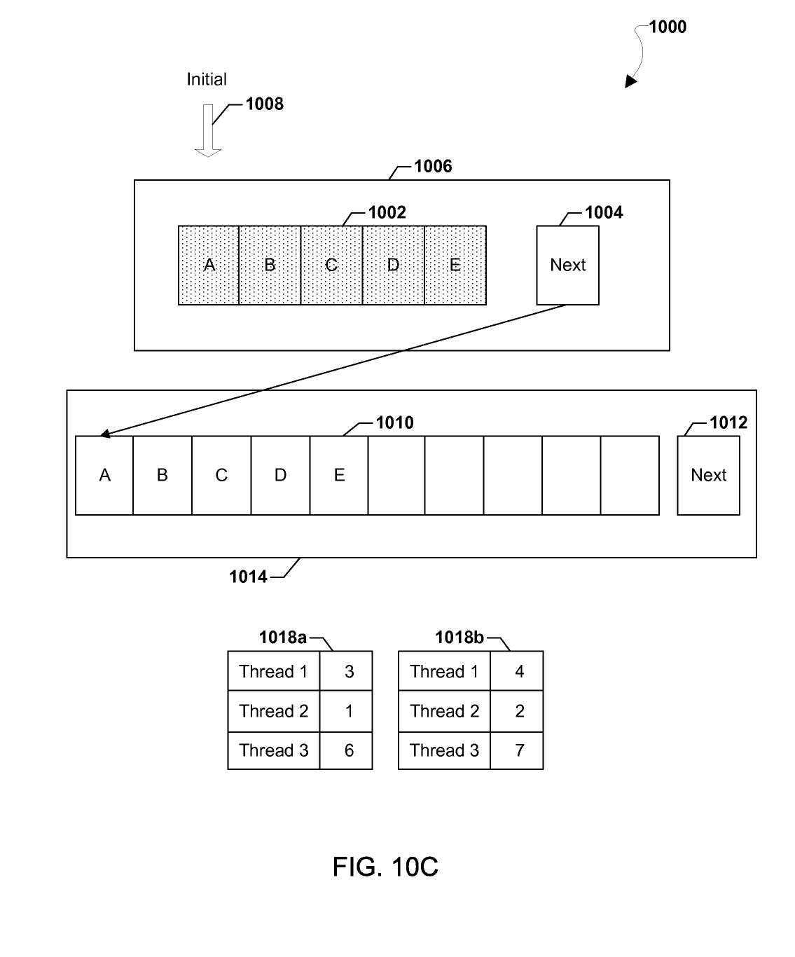

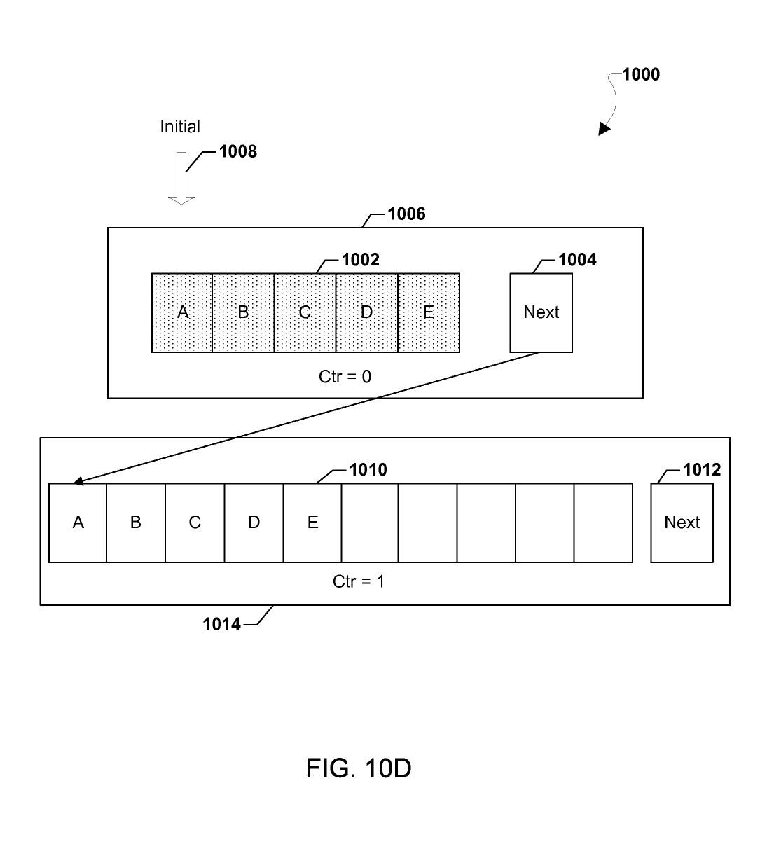

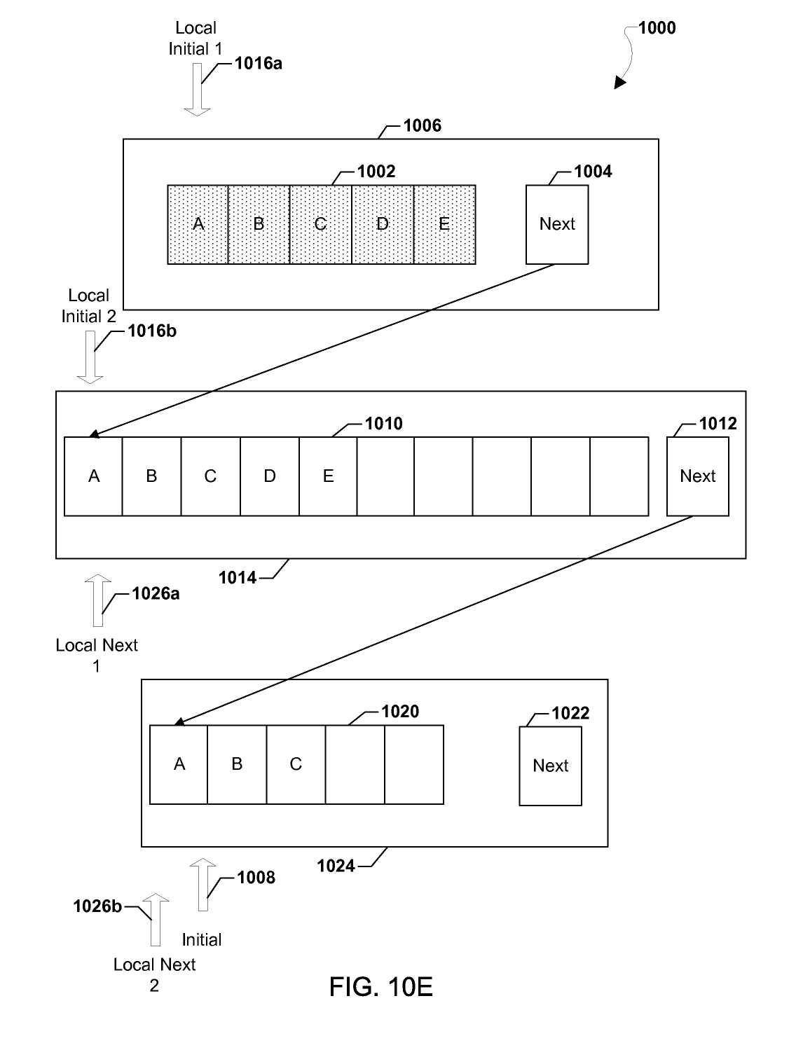

Once the array 902 becomes full due to changes by threads accessing the array 902, the computing device processor may allocate a larger portion of memory for the array. This is illustrated in FIG. 10A, which includes data structures 1000. The data structures 1000 include an array 1002 and a next pointer 1004, which in combination may be referred to as a passive container structure 1006. The processor allocates a second portion of memory for a new active container structure 1014 that contains a larger array 1010 and another next pointer 1012. The contents of the array 1002 are copied into the array 1010. In addition, the next pointer 1004 is updated to point to the beginning of the active container structure 1014 (e.g. the beginning of the array 1010). The initial pointer 1008 still points to the beginning of the passive container structure 1006 and is not changed when the processor copies the array 1002.

Multiple threads may be concurrently accessing the passive container structure 1006 that contains the array 1002 even though a new larger version of the same array, namely the array 1010, has been created. As long as multiple threads are concurrently accessing the passive container structure 1006, memory reclamation is not performed on the passive container structure 1006.

In some embodiments, a single dedicated reclamation thread may reclaim memory in the data structures 1000 (i.e., only that thread may change the initial pointer 1008). Alternatively, multiple threads may have the ability to reclaim memory from the data structures 1000. There are a number of ways to implement memory reclamation on the data structures 1000 utilizing the initial pointer 1008, some of which are illustrated in FIGS. 10B-10E. FIG. 10B illustrates an example implementation for reclaiming memory from the data structures 1000. When memory allocated to the data structure can be reclaimed (e.g. when only one thread is accessing the passive container structure 1006), the thread may request that the data structure be locked by that thread. The processor executing the thread may create a local copy of the initial pointer 1008, shown as local initial pointer 1016 that points to the beginning of the passive container structure 1006 (i.e. the beginning of the array 1002). The processor executing the thread may update the initial pointer 1008 to point to the beginning of the active container structure 1014 (i.e. the beginning of the array 1010). After creating the local initial pointer 1016, the processor executing the thread may release the exclusive lock on the data structures 1000. The process of locking and unlocking may ensure that only the thread that is performing the memory reclamation has access to the passive container structure 1006. Any thread that accesses the data structures 1000 after the lock is released will start at the memory location pointed to by the next pointer 1004 (i.e. the active container structure 1014). The other concurrent threads may still access the active container structure 1014 during memory reclamation, but they do not have access to the passive container structure 1006.

The processor executing the thread may start the memory reclamation at the memory location pointed to by the local initial pointer 1016, i.e. the memory location of the beginning of the passive container structure 1006, which may be the beginning of the array 1002. The processor executing the thread then traverses the cells of the array 1002 and reclaims the memory used to store each cell. Once the processor executing the thread reaches the end of the array 1002, the memory reclamation is finished. In some embodiments, the processor executing the thread may collectively reclaim some or all of the cells of the array 1002 without traversing the cells. During the reclamation process, other threads may concurrently access the active container structure 1014. However, those threads may not access the passive container structure 1006 because the thread that is performing the memory reclamation had previously had exclusive access to the passive container structure 1006.

Thus, the processor executing the thread may reclaim the memory at the memory location indicated by the local initial pointer 1016 and any other memory in the array 1002, for instance, all the memory between the memory locations indicated by the local initial pointer 1016 and the next pointer 1004, and may also reclaim the memory used by the next pointer 1004. If the array 1010 becomes full and another portion of memory is allocated to store a larger version of the array 1010, the next pointer 1012 may be updated to point to the location of the new array while the initial pointer 1008 continues to point to the beginning of the active container structure 1014 (which would become a passive container structure), which may be the beginning of the array 1010. Once a subsequent memory reclamation is initiated, the memory location indicated by the initial pointer 1008 and any other memory locations in the array 1010 and any other memory in the array 1010, for instance, all memory locations between the initial pointer 1008 and the next pointer 1012 may be reclaimed, and the memory used by the next pointer 1012 may also be reclaimed, and the initial pointer 1008 is once again updated to point to the same location at the next pointer 1012. This process may continue until the array is completely deleted. In this manner, the use of the initial pointer 1008 allows for efficient memory reclamation for a lock free data structure such as an array or hash table with low overhead.

FIG. 10C illustrates an example implementation for reclaiming memory from the data structures 1000 when there is a single dedicated reclamation thread. A table 1018a may be created that is associated with the data structures 1000. The table 1018a may include entries for every thread that may access the data structures 1000, along with a sequence number or counter for the number of times that thread has accessed the data structures 1000. For example, the table 1018a shows that there are three threads that have accessed the data structures 1000, with Thread 1 accessing the data structures 1000 three times, Thread 2 accessing the data structures 1000 once, and Thread 3 accessing the data structures 1000 six times. The table 1018a may or may not include an entry for the dedicated reclamation thread.

To initiate memory reclamation, the processor executing the dedicated reclamation thread may read or store a local copy of the next pointer 1004 and take a snapshot of the table 1018a. The processor executing the dedicated reclamation thread may then wait until every sequence number in the table 1018a has been incremented by at least one (except for the entry for the dedicated reclamation thread, if included in the table), shown in table 1018b. This means that every thread has finished its previous access, and has initiated a new access to the data structures 1000. When a new access is initiated, the threads start at the memory location pointed to by the next pointer 1004 (i.e. the active container structure 1014), thus ensuring that no threads are still accessing the passive container structure 1006. Once the processor executing the dedicated reclamation thread determines that every thread is only accessing the active container structure 1014 (for example, by comparing the snapshot of the table 1018a with the current state of the table 1018b), memory reclamation may be initiated on the passive container structure 1006. The processor executing the dedicated reclamation thread may reclaim memory starting from the memory location pointed to by the initial pointer 1008 (i.e., the beginning of the passive container structure 1006) until it reaches the memory location pointed to by the next pointer 1004 (i.e., the beginning of the active container structure 1014), and then modify the initial pointer 1008 to point to the same memory location as the next pointer 1004.

FIG. 10D illustrates another example implementation for reclaiming memory from the data structures 1000 when there is a single dedicated reclamation thread. Each container structure in the data structures 1000 may store an additional counter. The counter may initiate whether a thread is currently accessing that container structure. For example the counter may be set to zero if no thread is accessing the container structure, such as illustrated for the passive container structure 1006. When a thread accesses the container structure, the thread may increment the counter to one, such as illustrated for the active container structure 1014. Once the thread finishes accessing the container structure, the thread may decrement the counter back to zero.

The processor executing the dedicated reclamation thread may store a local copy of the next pointer 1004 and monitor the counter for the passive container structure 1006. When the counter for the passive container structure 1006 is zero, this indicates that no threads are still accessing the passive container structure 1006. All new accesses will start at the active container structure 1014. At that point, the processor executing the dedicated reclamation thread may reclaim memory starting from the memory location pointed to by the initial pointer 1008 (i.e., the beginning of the passive data structure 1006) until it reaches the memory location pointed to by the next pointer 1004 (i.e., the beginning of the active container structure 1014), and then modify the initial pointer 1008 to point to the same memory location as the next pointer 1004.

FIG. 10E illustrates an example implementation for concurrent memory reclamation by multiple threads that have the ability to reclaim memory. Multiple threads may obtain exclusive access to non-overlapping passive container structures, and thus each thread may reclaim memory on those passive data structures in parallel. The processor executing a first thread may, for example, add entries to the array 1002 that cause the allocation of a new, bigger array 1010. The array 1002 and the next pointer 1004 become part of passive data structure 1006. The processor executing the first thread may initiate memory reclamation on the passive container structure 1006 in a manner similar to that described with reference to FIG. 10B. That is, the processor executing the first thread may obtain an exclusive lock on the data structures 1000, create local copies of the initial pointer 1008 and the next pointer 1004 (e.g. local initial pointer 1016a and local next pointer 1026a), move the initial pointer 1008 to the beginning of the array 1010, and unlock the data structures 1000.

While the processor executing the first thread reclaims memory in the passive container structure 1006, the processor executing a second thread may access the data structures 1000 and remove entries in the array 1010, causing the allocation of a new, smaller array 1020. At that point the next pointer 1012 points to the beginning of the array 1020, which along with the next pointer 1022 forms the new active container structure 1024. The container structure 1014 becomes a passive container structure. The processor executing the second thread may also initiate memory reclamation on the passive container structure 1014 in a manner similar to that described with reference to FIG. 10B. That is, the processor executing the first thread may obtain an exclusive lock on the data structures 1000, create local copies of the initial pointer 1008 and the next pointer 1012 (e.g. local initial pointer 1016b and local next pointer 1026b), move the initial pointer 1008 to the beginning of the array 1020, and unlock the data structures 1000. The processor executing the second thread may then reclaim the memory in the passive container structure 1014 while the processor executing the first thread is reclaiming memory in the passive container structure 1006. This process is extendable to any number of concurrent threads to reclaim non-overlapping passive container structures.

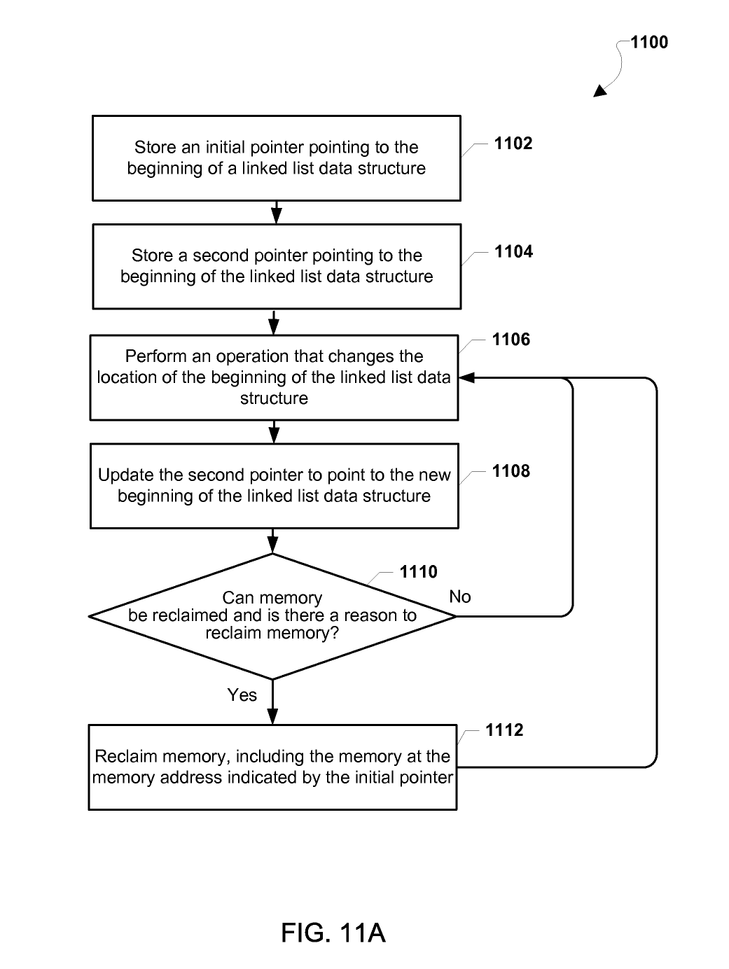

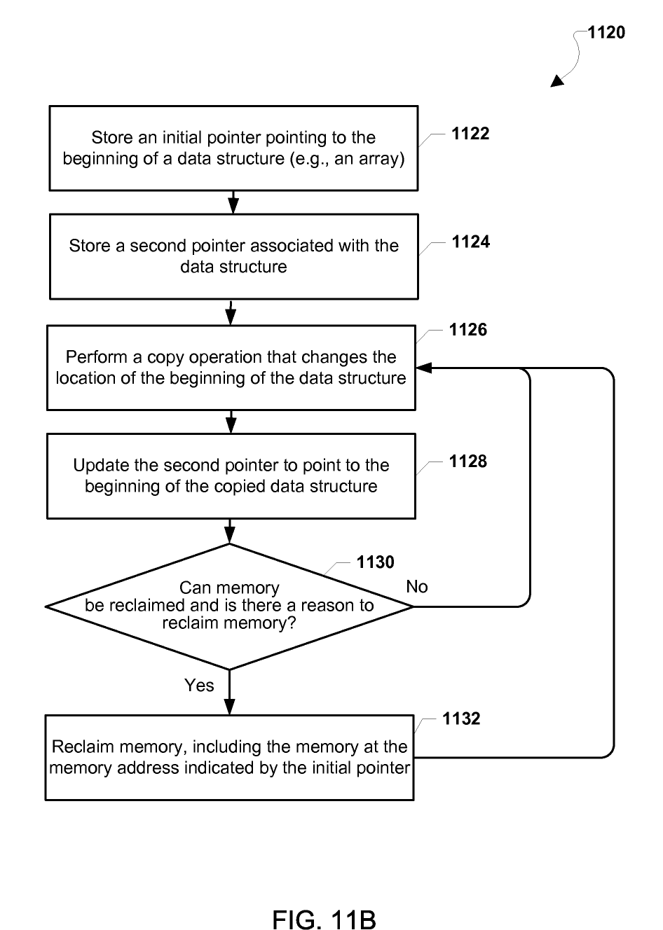

FIG. 11A illustrates a method 1100 for reclaiming memory in a computing device according to an embodiment. The method 1100 may be particularly useful for linked list data structures and may be implemented by a processor of a computing device (e.g. the CPU 102 of the computing device 100 in FIG. 1). The computer device processor may execute one or more threads that may concurrently access one or more data structures.

In block 1102, the processor may store an initial pointer that points to the memory location of the beginning of a data structure. The data structure may be a FIFO linked list. The initial pointer may be used to track the beginning of the data structure and may remain constant even though one or more threads may alter the beginning point of the data structure. In block 1104, the processor may store a second pointer. For example, if the data structure is a FIFO linked list, the second pointer may be the head pointer that points to the current head node of the linked list.

In block 1106, the processor may perform an operation that changes the memory location of the beginning of the data structure, such a popping data of the beginning of the linked list. The processor may be executing one or more threads that may concurrently access the data structure. The instructions of one thread may cause the processor to perform the operation. For example, if the data structure is a FIFO linked list, the operation may be a pop( ) operation that removes the head node from the linked list. The beginning of the linked list is now the next node after the head node, and so the memory location of the beginning of the linked list has changed.

In block 1108, the processor may update the second pointer to point to the new memory location of the beginning of the data structure. For example, if the data structure is a FIFO linked list, the second pointer may be the head pointer. When the head node is removed from the linked list, the second pointer may be updated to point to the new head node of the linked list. Memory locations at the initial pointer and any between the initial pointer and the second pointer (e.g. nodes that have been removed from the data structure) may be considered part of the passive portion of the data structure, while memory locations that remain in the data structure may be considered part of the active portion of the data structure.

In determination block 1110, the processor may determine whether memory addresses allocated to the data structure may be reclaimed, such as when only one thread has exclusive access to the passive portion of the data structure. Multiple threads may concurrently access the data structure at various times, but at some point only one thread may be accessing the passive portion of the data structure, which may an opportunity to reclaim memory allocated to the data structure. There are a number of ways that the processor may determine whether only one thread has exclusive access for a thread that is performing the memory reclamation. For example, when multiple threads can reclaim memory a single thread that is currently accessing the passive portion of the data structure, the processor may request a lock on the data structure. The processor may create local copies of the initial pointer and the second pointer, and then update the initial pointer to point to the same memory location as the second pointer (e.g. the current head node of a FIFO linked list). The processor may then release the lock on the data structure. When there is a single dedicated reclamation thread, the processor may utilize a sequence number table as illustrated in FIG. 6C or a per node counter as illustrated in FIG. 6D to determine when only the dedicated reclamation thread has exclusive access to the passive portion of the data structure.

The processor may also determine whether there is a motivation or need to reclaim memory addresses in the data structure. For example, the processor may determine that memory resources are running low and more memory needs to be freed for use. The processor may perform memory reclamation periodically, or in response to certain instructions, or may perform memory reclamation when only one thread is currently accessing the passive portion of the data structure.

In response to determining that memory may not or need not be reclaimed, (i.e. determination block 1110=“No”), the processor may continue to perform operations by one or more threads that may change the memory location of the beginning of the data structure (i.e. return to the operation illustrated in block 1106). In other words, the processor may continue processing operations on the data structure as it waits for an opportunity to conduct memory reclamation.

In response to determining that memory may be reclaimed (i.e. determination block 1110=“Yes”), the processor may reclaim memory, including the memory at the memory address indicated by the initial pointer, in block 1112. In some embodiments, the processor may, in block 1112, reclaim memory, including the memory at the memory address indicated by the initial pointer and any memory between the memory addresses indicated by the initial and second pointers. The processor may initiate memory reclamation, for example, by calling a destructor function for objects in the data structure. The processor may reclaim the memory starting from the local initial pointer and continue reclaiming memory by traversing the linked list until it reaches the local second pointer. For example, if the data structure is a FIFO linked list, the local initial pointer would be pointing to the beginning of the linked list when it was first initialized or after the last memory reclamation. The local second pointer points to the current head node of the linked list. The processor may start at the memory location of the local initial pointer and reclaim the memory of each removed node until it reaches the current head node (indicated by the local second pointer). The nodes that had been removed from the linked list still retain their inter-node pointers, so the processor may simply traverse the linked removed nodes until reaching the current head node. Other threads may concurrently access the active portion of the data structure during memory reclamation on the passive portion of the data structure. In other words, other threads may concurrently access memory locations of the data structure that are outside of the memory located at the initial pointer and between the initial pointer and the second pointer while the memory located at the initial pointer and between the initial and second pointers is being reclaimed. In some embodiments, concurrent memory reclamation may also occur on the data structure. For example, multiple threads may obtain locks for multiple non-overlapping sections of the passive portion of the data structure, and thus each thread may reclaim memory the portions of the passive data structure for which it has exclusive access.

After the processor reclaims the memory at the initial pointer and between the initial and second pointers, the processor may then continue to perform operations on the data structure by one or more threads, which may change the location of the beginning of the data structure (i.e. return to the operation illustrated in block 1106). This process of memory reclamation may continue until the data structure is completely deleted. In this manner, the method 1100 provides a way to reclaim memory on a lock free data structure with low overhead.

FIG. 11B illustrates a method 1120 for reclaiming memory in a computing device according to an embodiment. The method 1120 may be particularly useful for hash table or array data structures and may be implemented by a processor of a computing device (e.g. the CPU 102 of the computing device 100 in FIG. 1). The computer device processor may execute one or more threads that may concurrently access one or more data structures.

In block 1122, the processor may store an initial pointer that points to the memory location of the beginning of a data structure. The data structure may be an array or hash table. The initial pointer may be used to track the beginning of the data structure and may remain constant even though one or more threads may alter the beginning point of the data structure. In block 1124, the processor may store a second pointer. For example, if the data structure is an array or hash table, the second pointer may be a next pointer that is associated with the data structure.

In block 1126, the processor may perform an operation that changes the memory location of the beginning of the data structure. The processor may be executing one or more threads that may concurrently access the data structure. The instructions of one thread may cause the processor to perform the operation. For example, if the data structure is an array or hash table, a thread may write data to the data structure such that it becomes full. In response, the processor may perform a copy operation in which it allocates a second portion of memory to store a copy of the data structure, and copies the data structure from its original location to the new location. This portion of memory is in a different location than the memory location where the data structure is currently stored, and so the memory location of the beginning of the data structure changes.

In block 1128, the processor may update the second pointer to point to the new memory location of the beginning of the data structure. For example, if the data structure is an array or a hash table, the second pointer may be a next pointer associated with the data structure. The operation may be the allocation of a new portion of memory to store the data structure, and the second pointer may be updated to point to the memory location of the beginning of the copied data structure in the new portion of memory. Memory locations at the initial pointer and between the initial pointer and the second pointer (e.g. the original data structure) may be considered part of the passive portion of the data structure, while memory locations that remain in the data structure (e.g. the copied data structure) may be considered part of the active portion of the data structure.

In determination block 1130, the processor may determine whether memory addresses allocated to the data structure may be reclaimed, such as when only one thread has exclusive access to the passive portion of the data structure. Multiple threads may concurrently access the data structure at various times, but at some point only one thread may be accessing the passive portion of the data structure, which may provide an opportunity to reclaim memory allocated to the data structure. There are a number of ways that the processor may obtain exclusive access for a thread that is performing the memory reclamation. For example, when multiple threads may reclaim memory a single thread that is currently accessing the passive portion of the data structure, the processor may request a lock on the data structure. The processor may create a local copy of the initial pointer, and then update the initial pointer to point to the same memory location as the second pointer (e.g. beginning of the copied data structure). The processor may then release the lock on the data structure. When there is a single dedicated reclamation thread, the processor may utilize a sequence number table as illustrated in FIG. 10C or a per node counter as illustrated in FIG. 10D to determine when no threads are accessing the memory that is being reclaimed (e.g. the passive container structure).

The processor may also determine whether there is a motivation or need to reclaim memory addresses in the data structure. For example, the processor may determine that memory resources are running low and more memory needs to be freed for use. The processor may perform memory reclamation periodically, or in response to certain instructions, or may perform memory reclamation when only one thread is currently accessing the passive portion of the data structure.

In response to determining that memory may not be reclaimed, (i.e. determination block 1130=“No”), the processor may continue to perform operations by one or more threads that may change the memory location of the beginning of the data structure (i.e. return to the operation illustrated in block 1126). In other words, the processor may continue processing operations on the data structure as it waits for an opportunity to conduct memory reclamation.

In response to determining that memory may be reclaimed (i.e. determination block 1130=“Yes”), the processor may reclaim memory, including the memory at the memory address indicated by the initial pointer, in block 1132. In some embodiments, the processor may, in block 1132, reclaim the memory storing the original data structure, including the memory at the memory address indicated by the initial pointer and the other memory locations, if any, in the original data structure, for instance, memory between the memory addresses indicated by the initial and second pointers. The processor may initiate memory reclamation, for example by calling a destructor function for objects in the data structure. The processor may reclaim the memory starting from the local initial pointer through the end of the original data structure or until it reaches the beginning of the copied data structure (i.e., the memory location pointed to by the second pointer). For example, if the data structure is an array or hash table that has been copied from one memory location to another memory location, the local initial pointer would point to the memory location of the beginning of the data structure at the original memory location. The second pointer is the next pointer and points to the memory location of the beginning of the copied data structure at the new memory location. The processor may start at the memory location of the local initial pointer and reclaim the memory of the original data structure through the end of the original data structure or until it reaches the beginning of the copied data structure. Other threads may concurrently access the active portion of the data structure during memory reclamation on the passive portion of the data structure. In other words, other threads may concurrently access memory locations of the data structure that are outside of the memory located in the original data structure while the memory located in the original data structure is being reclaimed. For example, other threads may concurrently access the copied data structure while the original data structure is being reclaimed. In some embodiments, concurrent memory reclamation may also occur on the various copies of the array. For example, multiple threads may obtain locks for multiple non-overlapping passive container structures containing the arrays, and thus each thread may reclaim memory the passive container structure for which it has exclusive access.

After the processor reclaims the memory in the original data structure, the processor may continue to perform operations on the data structure by one or more threads, which may change the location of the beginning of the data structure (i.e. return to the operation illustrated in block 1126). This process of memory reclamation may continue until the data structure is completely deleted. In this manner, the method 1120 provides a way to reclaim memory on a lock free data structure with low overhead.

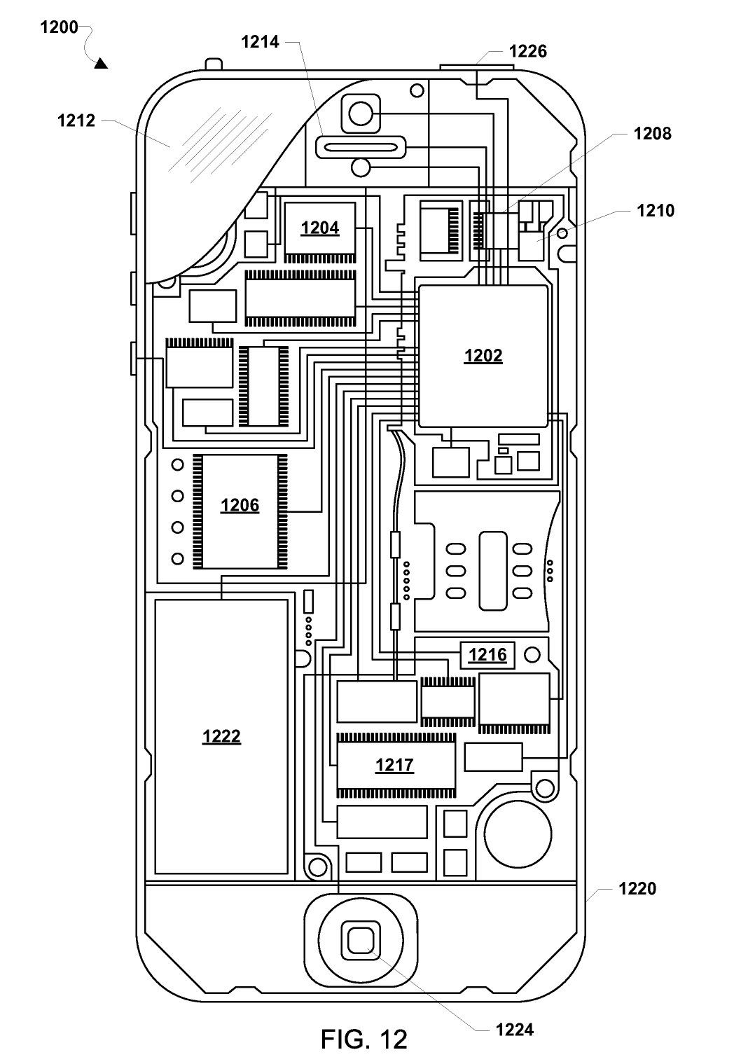

Various embodiments may be implemented in any of a variety of computing devices, an example of which (e.g., communication device 1200) is illustrated in FIG. 12. According to various embodiments, the communication device 1200 may be similar to the computing device 100 as described above with reference to FIG. 1. As such, the communication device 1200 may implement some or all of the methods 1100 and 1120 in FIGS. 11A and 11B.

A communication device 1200 may include a processor 1202 coupled to a touchscreen controller 1204 and an internal memory 1206. The processor 1202 may be one or more multi-core integrated circuits designated for general or specific processing tasks. The internal memory 1206 may be volatile or non-volatile memory, and may also be secure and/or encrypted memory, or unsecure and/or unencrypted memory, or any combination thereof. The touchscreen controller 1204 and the processor 1202 may also be coupled to a touchscreen panel 1212, such as a resistive-sensing touchscreen, capacitive-sensing touchscreen, infrared sensing touchscreen, etc. Additionally, the display of the communication device 1200 need not have touch screen capability.

A communication device 1200 may have a cellular network transceiver 1208 coupled to the processor 1202 and to an antenna 1210 and configured for sending and receiving cellular communications. The transceiver 1208 and the antenna 1210 may be used with the above-mentioned circuitry to implement various embodiment methods. The communication device 1200 may include one or more SIM cards 1216 coupled to the transceiver 1208 and/or the processor 1202 and may be configured as described above. The communication device 1200 may include a cellular network wireless modem chip 1217 that enables communication via a cellular network and may be coupled to the processor.

A communication device 1200 may also include speakers 1214 for providing audio outputs. The communication device 1200 may also include a housing 1220, constructed of a plastic, metal, or a combination of materials, for containing all or some of the components discussed herein. The communication device 1200 may include a power source 1222 coupled to the processor 1202, such as a disposable or rechargeable battery. The rechargeable battery may also be coupled to the peripheral device connection port to receive a charging current from a source external to the communication device 1200. The communication device 1200 may also include a physical button 1224 for receiving user inputs. The communication device 1200 may also include a power button 1226 for turning the communication device 1200 on and off.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present embodiments.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of various embodiments is provided to enable any person skilled in the art to make or use the claims. Various modifications to these embodiments will be readily apparent to those skilled in the art, and the generic principles defined herein may be applied to some embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method for reclaiming memory in a computing device, comprising:
storing, on the computing device, a first pointer pointing to a first memory location storing the beginning of a data structure, wherein a plurality of threads executing on the computing device may concurrently access the data structure;
storing, on the computing device, a second pointer;
performing an operation on the data structure, wherein the operation changes a location of the beginning of the data structure from the first memory location to a second memory location;
updating the second pointer to point to the second memory location;
determining whether memory allocated to the data structure may be reclaimed; and
reclaiming memory allocated to the data structure, including memory located at the first memory location pointed to by the first pointer, in response to determining that memory allocated to the data structure may be reclaimed.

2. The method of claim 1, the method further comprising:
updating the first pointer to point to the second memory location.

3. The method of claim 1, wherein the data structure is a first-in-first-out (FIFO) linked list, and wherein storing the second pointer comprises setting the second pointer to point to the first memory location.

4. The method of claim 1, wherein:
the data structure is a FIFO linked list comprising at least a first node and a second node;
the first node includes a pointer to the second node; and
performing an operation on the data structure comprises popping the first node from the FIFO linked list so that the second node becomes the beginning of the FIFO linked list, wherein the pointer to the second node is preserved.

5. The method of claim 1, wherein the data structure is stored in a first portion of memory, and wherein performing an operation on the data structure comprises:
allocating a second portion of memory for the data structure; and
copying the data structure from the first portion of memory to the second portion of memory.

6. The method of claim 1, wherein the plurality of threads concurrently access memory locations of the data structure outside of the memory located at the first memory location pointed to by the first pointer and any memory of the data structure located between the first memory location pointed to by the first pointer and the second memory location pointed to by the second pointer during reclamation of the memory located at the first memory location pointed to by the first pointer and any memory of the data structure located between the first memory location pointed to by the first pointer and the second memory location pointed to by the second pointer.

7. The method of claim 1, wherein determining whether memory allocated to the data structure may be reclaimed comprises obtaining, by one thread, exclusive access to memory locations of the data structure at the first memory location pointed to by the first pointer and any memory of the data structure located between the first memory location pointed to by the first pointer and the second memory location pointed to by the second pointer.

8. The method of claim 7, wherein obtaining, by one thread, exclusive access to memory locations of the data structure at the first memory location pointed to by the first pointer and any memory of the data structure located between the first memory location pointed to by the first pointer and the second memory location pointed to by the second pointer comprises:
locking the data structure;
creating a copy of the first pointer;
creating a copy of the second pointer and
unlocking the data structure.

9. The method of claim 8, wherein reclaiming memory allocated to the data structure comprises reclaiming the memory located at the first memory location pointed to by the copy of the first pointer and any memory of the data structure located between the first memory location pointed to by the copy of the first pointer and the second memory location pointed to by the copy of the second pointer.

10. The method of claim 1, wherein determining whether memory allocated to the data structure may be reclaimed comprises utilizing a table or counter to determine when only a single thread has exclusive access to memory locations of the data structure at the first memory location pointed to by the first pointer and any memory of the data structure located between the first memory location pointed to by the first pointer and the second memory location pointed to by the second pointer.

11. The method of claim 1, wherein reclaiming memory allocated to the data structure comprises, by the plurality of threads, concurrently reclaiming non-overlapping portions of the memory allocated to the data structure.

12. A computing device, comprising:
a memory; and
a processor coupled to the memory and configured with processor-executable instructions to perform operations comprising:
storing a first pointer pointing to a first memory location storing the beginning of a data structure, wherein a plurality of threads executing on the computing device may concurrently access the data structure;
storing a second pointer;
performing an operation on the data structure, wherein the operation changes a location of the beginning of the data structure from the first memory location to a second memory location;
updating the second pointer to point to the second memory location;
determining whether memory allocated to the data structure may be reclaimed; and
reclaiming memory allocated to the data structure, including memory located at the first memory location pointed to by the first pointer, in response to determining that memory allocated to the data structure may be reclaimed.

13. The computing device of claim 12, wherein the processor is further configured with processor-executable instructions to perform operations comprising:
updating the first pointer to point to the second memory location.

14. The computing device of claim 12, wherein the data structure is a first-in-first-out (FIFO) linked list, and wherein the processor is further configured with processor-executable instructions to perform operations such that storing the second pointer comprises setting the second pointer to point to the first memory location.

15. The computing device of claim 12, wherein:
the data structure is a FIFO linked list comprising at least a first node and a second node;
the first node includes a pointer to the second node; and
the processor is further configured with processor-executable instructions to perform operations such that performing an operation on the data structure comprises popping the first node from the FIFO linked list so that the second node becomes the beginning of the FIFO linked list, wherein the pointer to the second node is preserved.

16. The computing device of claim 12, wherein the data structure is stored in a first portion of memory, and wherein the processor is further configured with processor-executable instructions to perform operations such that performing an operation on the data structure comprises:
allocating a second portion of memory for the data structure; and
copying the data structure from the first portion of memory to the second portion of memory.

17. The computing device of claim 12, wherein the plurality of threads may concurrently access memory locations of the data structure outside of the memory located at the first memory location pointed to by the first pointer and any memory of the data structure located between the first memory location pointed to by the first pointer and the second memory location pointed to by the second pointer during reclamation of the memory located at the first memory location pointed to by the first pointer and any memory of the data structure located between the first memory location pointed to by the first pointer and the second memory location pointed to by the second pointer.

18. The computing device of claim 12, wherein the processor is further configured with processor-executable instructions to perform operations such that determining whether memory allocated to the data structure may be reclaimed comprises obtaining, by one thread, exclusive access to memory locations of the data structure at the first memory location pointed to by the first pointer and any memory of the data structure located between the first memory location pointed to by the first pointer and the second memory location pointed to by the second pointer.

19. The computing device of claim 18, wherein the processor is further configured with processor-executable instructions to perform operations such that obtaining, by one thread, exclusive access to memory locations of the data structure at the first memory location pointed to by the first pointer and any memory of the data structure located between the first memory location pointed to by the first pointer and the second memory location pointed to by the second pointer comprises:
locking the data structure;
creating a copy of the first pointer;
creating a copy of the second pointer and
unlocking the data structure.

20. The computing device of claim 19, wherein the processor is further configured with processor-executable instructions to perform operations such that reclaiming memory allocated to the data structure comprises reclaiming the memory located at the first memory location pointed to by the copy of the first pointer and any memory of the data structure located between the first memory location pointed to by the copy of the first pointer and the second memory location pointed to by the copy of the second pointer.

21. The computing device of claim 12, wherein the processor is further configured with processor-executable instructions to perform operations such that determining whether memory allocated to the data structure may be reclaimed comprises utilizing a table or counter to determine when only a single thread has exclusive access to memory locations of the data structure at the first memory location pointed to by the first pointer and any memory of the data structure located between the first memory location pointed to by the first pointer and the second memory location pointed to by the second pointer.

22. The computing device of claim 12, wherein the processor is further configured with processor-executable instructions to perform operations such that reclaiming memory allocated to the data structure comprises, by the plurality of threads, concurrently reclaiming non-overlapping portions of the memory allocated to the data structure.

23. A non-transitory processor-readable storage medium having stored thereon processor-executable instructions configured to cause a processor of a computing device to perform operations comprising:
storing a first pointer pointing to a first memory location storing the beginning of a data structure, wherein a plurality of threads executing on the computing device may concurrently access the data structure;
storing a second pointer;
performing an operation on the data structure, wherein the operation changes a location of the beginning of the data structure from the first memory location to a second memory location;
updating the second pointer to point to the second memory location;
determining whether memory allocated to the data structure may be reclaimed; and
reclaiming memory allocated to the data structure, including memory located at the first memory location pointed to by the first pointer, in response to determining that memory allocated to the data structure may be reclaimed.

24. The non-transitory processor-readable storage medium of claim 23, wherein the stored processor-executable instructions are configured to cause a processor of the computing device to perform operations further comprising:
updating the first pointer to point to the second memory location.

25. The non-transitory processor-readable storage medium of claim 23, wherein the data structure is a first-in-first-out (FIFO) linked list, and wherein the stored processor-executable instructions are configured to cause a processor of the computing device to perform operations such that storing the second pointer comprises setting the second pointer to point to the first memory location.

26. The non-transitory processor-readable storage medium of claim 23, wherein:
the data structure is a FIFO linked list comprising at least a first node and a second node;
the first node includes a pointer to the second node; and
the stored processor-executable instructions are configured to cause a processor of the computing device to perform operations such that performing an operation on the data structure comprises popping the first node from the FIFO linked list so that the second node becomes the beginning of the FIFO linked list, wherein the pointer to the second node is preserved.

27. The non-transitory processor-readable storage medium of claim 23, wherein the data structure is stored in a first portion of memory, and wherein the stored processor-executable instructions are configured to cause a processor of the computing device to perform operations such that performing an operation on the data structure comprises:
allocating a second portion of memory for the data structure; and
copying the data structure from the first portion of memory to the second portion of memory.

28. The non-transitory processor-readable storage medium of claim 23, wherein the stored processor-executable instructions are configured to cause a processor of the computing device to perform operations such that determining whether memory allocated to the data structure may be reclaimed comprises obtaining, by one thread, exclusive access to memory locations of the data structure at the first memory location pointed to by the first pointer and any memory of the data structure located between the first memory location pointed to by the first pointer and the second memory location pointed to by the second pointer.

29. The non-transitory processor-readable storage medium of claim 23, wherein the stored processor-executable instructions are configured to cause a processor of the computing device to perform operations such that reclaiming memory allocated to the data structure comprises, by the plurality of threads, concurrently reclaiming non-overlapping portions of the memory allocated to the data structure.

30. A computing device, comprising:
means for storing a first pointer pointing to a first memory location storing the beginning of a data structure, wherein a plurality of threads executing on the computing device may concurrently access the data structure;
means for storing a second pointer;
means for performing an operation on the data structure, wherein the operation changes a location of the beginning of the data structure from the first memory location to a second memory location;
means for updating the second pointer to point to the second memory location;
means for determining whether memory allocated to the data structure may be reclaimed; and
means for reclaiming memory allocated to the data structure including memory located at the first memory location pointed to by the first pointer, in response to determining that memory allocated to the data structure may be reclaimed.
